(19) United States
(12) Patent Application Publication
(10) Pub. No.: US 2017/0305381 A1
(43) Pub. Date: Oct. 26, 2017

(54) AIRBAG APPARATUS AND CONTROL METHOD THEREOF

(71) Applicant: Hyundai Mobis Co., Ltd., Seoul (KR)

(72) Inventor: Hae Wook KWON, Yongin-si (KR)

(21) Appl. No.: 15/481,883

(22) Filed: Apr. 7, 2017

(30) Foreign Application Priority Data
Apr. 21, 2016 (KR) 10-2016-0048834

(51) Int. Cl. B60R 21/2338; B60R 21/239; B60R 21/233; B60R 21/231

(52) U.S. Cl. CPC B60R 21/2338; B60R 21/239; B60R 21/233; B60R 21/231; B60R 2021/23382; B60R 2021/23386

(57) ABSTRACT

An airbag apparatus may include: an airbag cushion having a vent hole; a cover member covering the vent hole; a vent tether connected to the cover member and configured to adjust an opening degree of the vent hole by pulling the cover member when the airbag cushion is expanded; and a release device connected to the vent tether and configured to release the vent tether from pulling the cover member.

### CROSS-REFERENCES TO RELATED APPLICATION

The application claims priority from and the benefit of Korean Patent Application No. 10-2016-0048834, filed on Apr. 21, 2016, which is hereby incorporated by reference for all purposes as if set forth herein.

### BACKGROUND

### FIELD

Exemplary embodiments relate to an airbag apparatus and a method of controlling thereof. More particularly, exemplary embodiments relate to an airbag apparatus capable of reducing damage of the head and neck of a passenger, and a method of controlling thereof.

### DISCUSSION OF THE BACKGROUND

In general, a vehicle has an airbag apparatus to protect a passenger. Airbags may be installed at various positions on a vehicle, depending on body parts of a passenger which are to be protected. For example, a front airbag apparatus is installed in front of a passenger.

When an impact is applied to the vehicle, gas is injected into the front airbag apparatus. When an airbag cushion applied to the front airbag apparatus is expanded by gas, the airbag cushion buffers an impact applied to the passenger, thereby reducing a body injury of the passenger.

However, in a conventional airbag apparatus, when the amount of gas filling the airbag apparatus is increased, collision acceleration applied to the head of the passenger may rise, causing damage the head or neck of the passenger.

The above information disclosed in this Background section is only for enhancement of understanding of the background of the invention and, therefore, it may contain information that does not constitute prior art.

### SUMMARY

Exemplary embodiments provide an airbag apparatus capable of reducing damage of the head and neck of a passenger, and a method of controlling thereof.

Additional features of the invention will be set forth in the description which follows, and in part will be apparent from the description, or may be learned by practice of the invention.

In an exemplary embodiment, an airbag apparatus includes an airbag cushion having a vent hole, a cover member covering the vent hole, a vent tether connected to the cover member and configured to adjust an opening degree of the vent hole by pulling the cover member when the airbag cushion is expanded, and a release device connected to the vent tether and configured to release the vent tether from pulling the cover member.

In another exemplary embodiment, a method of controlling an airbag apparatus includes injecting gas into an airbag cushion having a vent hole, increasing an opening degree of the vent hole by pulling a cover member covering the vent hole using a vent tether when the airbag cushion is expanded, and releasing the vent tether from pulling the cover member such that the cover member covers the vent hole when the internal pressure of the airbag cushion reaches a preset pressure.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a state in which an airbag apparatus in accordance with an embodiment of the present invention is installed at the front of a vehicle body.

FIG. 2 is a configuration diagram of the airbag apparatus in accordance with the embodiment of the present invention.

FIG. 3 is an expanded view of a first example of a cover member in the airbag apparatus in accordance with the embodiment of the present invention.

FIG. 4 is a diagram illustrating a state in which the cover member is opened by a vent tether in the airbag apparatus in accordance with the embodiment of the present invention.

FIG. 5 is an expanded view illustrating a state in which the cover member is opened by the vent tether in the airbag apparatus in accordance with the embodiment of the present invention.

FIG. 6 is a perspective view illustrating a state in which the cover member is opened by the vent tether in the airbag apparatus in accordance with the embodiment of the present invention.

FIG. 7 is a diagram illustrating a state in which the vent tether is released in the airbag apparatus in accordance with the embodiment of the present invention.

FIG. 8 is a flowchart illustrating a method of controlling an airbag apparatus in accordance with an embodiment of the present invention.

FIG. 9 is an expanded view of a second example of the cover member in the airbag apparatus in accordance with the embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

It will be understood that for purposes of this disclosure, “at least one of X, Y, and Z” can be construed as X only, Y only, Z only, or any combination of two or more items X, Y, and Z (e.g., XYZ, XYY, YZ, ZZ). Unless particularly described to the contrary, the term “comprise,” “configure,” “have,” or the like, which are described herein, will be understood to imply the inclusion of the stated components, and therefore should be construed as including other components, and not the exclusion of any other elements.

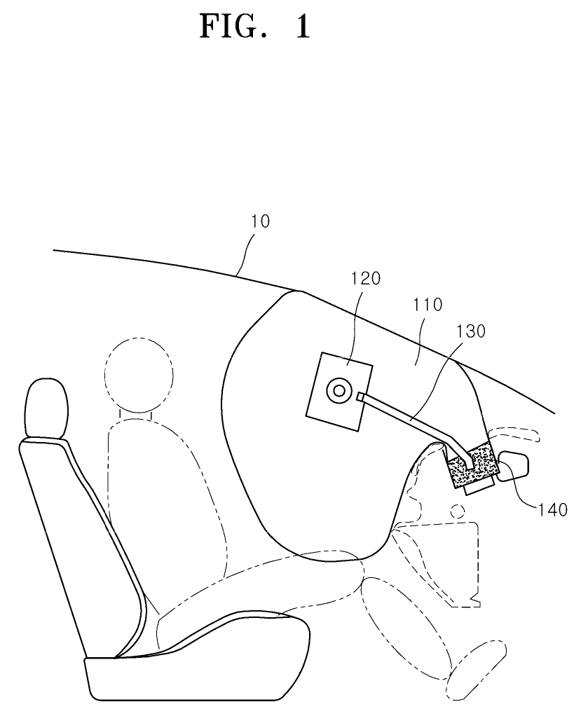

FIG. 1 is a diagram illustrating a state in which an airbag apparatus in accordance with an exemplary embodiment is installed at the front of a vehicle body.

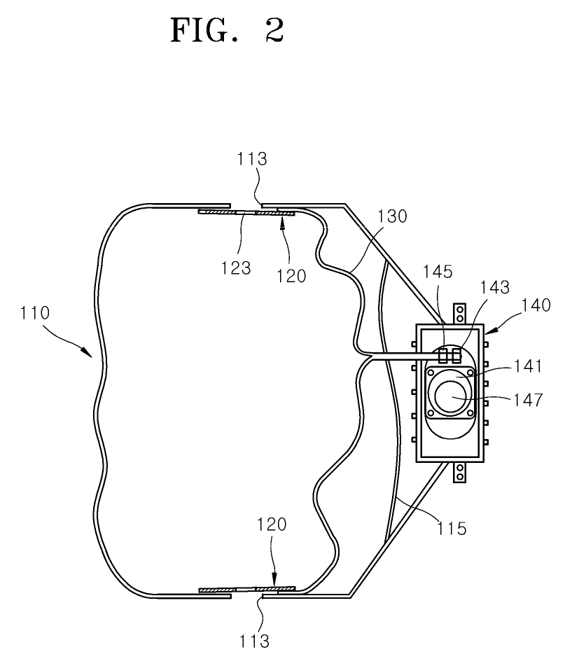

FIG. 2 is a configuration diagram illustrating the airbag apparatus in accordance with an exemplary embodiment.

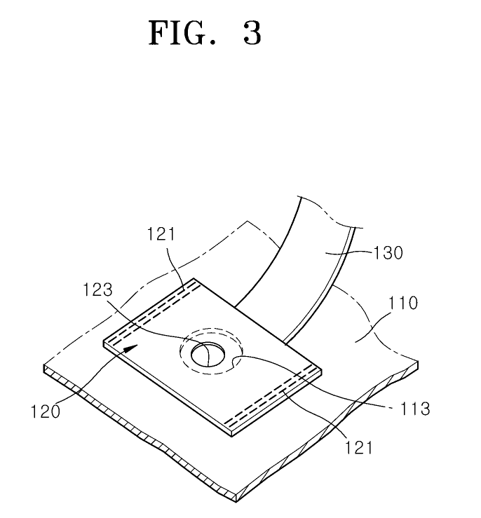

FIG. 3 is an expanded view of a first example of a cover member in the airbag apparatus in accordance with an exemplary embodiment.

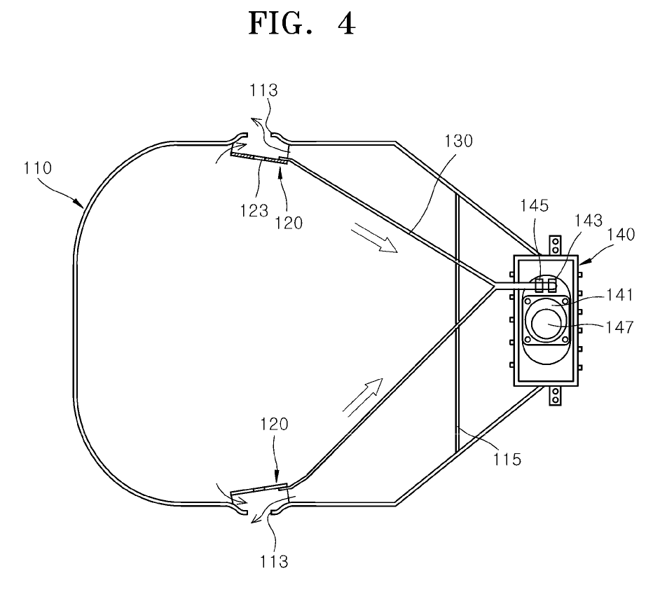

FIG. 4 is a diagram illustrating a state in which the cover member is opened by a vent tether in the airbag apparatus in accordance with an exemplary embodiment.

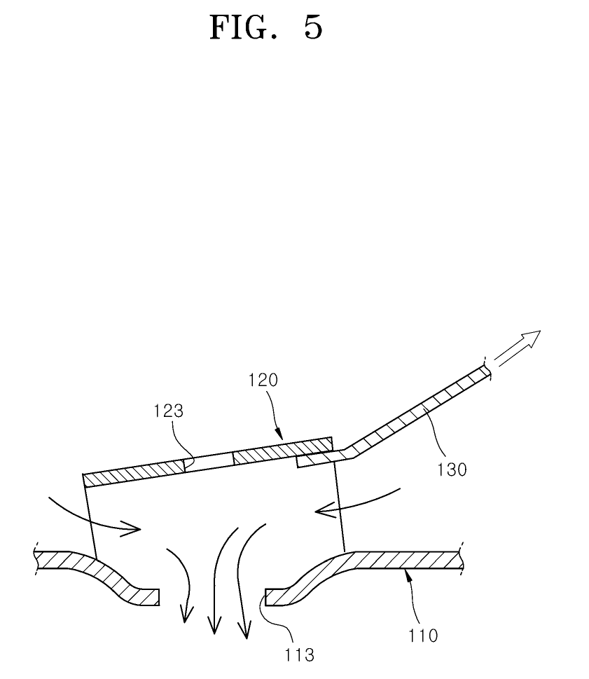

FIG. 5 is an expanded view illustrating a state in which the cover member is opened by the vent tether in the airbag apparatus in accordance with an exemplary embodiment.

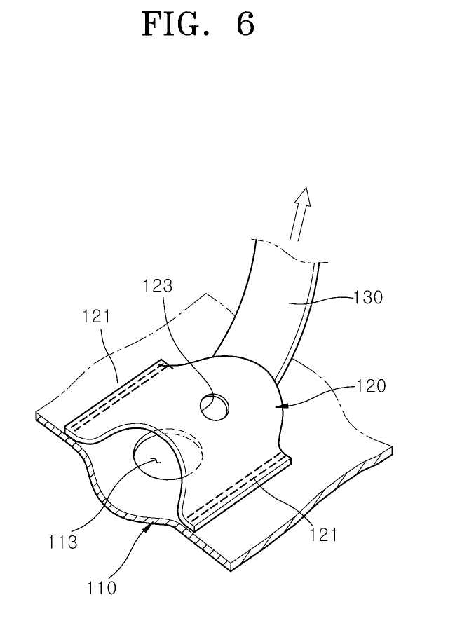

FIG. 6 is a perspective view illustrating a state in which the cover member is opened by the vent tether in the airbag apparatus in accordance with an exemplary embodiment.

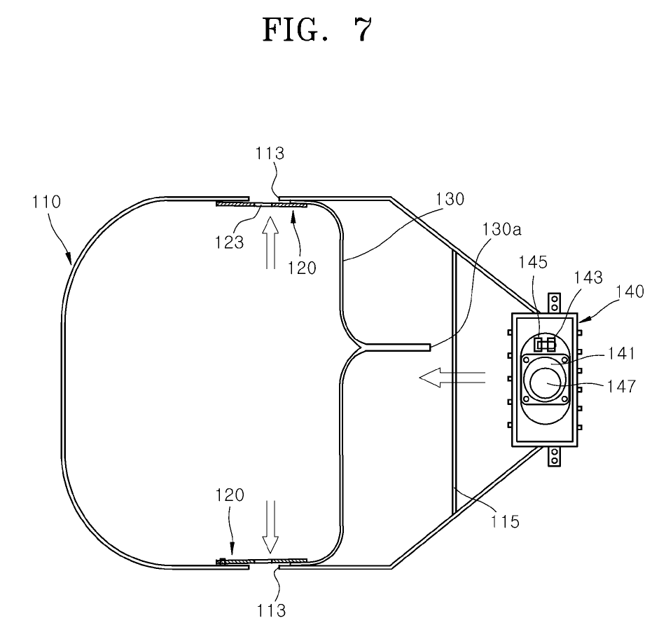

FIG. 7 is a diagram illustrating a state in which the vent tether is released in the airbag apparatus in accordance with an exemplary embodiment.

Referring to FIGS. 1 to 7, an airbag apparatus in accordance with the embodiment of the present invention includes an airbag cushion 110, a cover member 120, a vent tether 130, and a release device 140.

The airbag cushion 110 may be connected to an inflator (not illustrated) which injects gas. The airbag cushion 110 may be disposed at the front of a vehicle body 10, and protects the upper body and head of a passenger in a front seat.

The airbag cushion 110 may have a vent hole 113 for discharging internal gas to the outside. The airbag cushion 110 may include one or more vent holes 113 formed therein. The airbag cushion 110 may have an inner tether 115 for limiting the expansion shape or range of the airbag cushion 110.

The cover member 120 may cover the vent hole 113 so as to adjust the amount of gas discharged through the vent hole 113. The cover member 120 may have a communication hole 123 to communicate with the vent hole 113.

The communication hole 123 may have a smaller diameter than the vent hole 113. When the cover member 120 covers the vent hole 113, the amount of gas discharged through the communication hole 123 and the vent hole 113 may be adjusted.

The communication hole 123 may discharge the gas of the airbag cushion 110 through the vent hole 113 while communicating with the vent hole 113. The vent hole 113 may have a larger diameter than the communication hole 123. Thus, when the cover member 120 is separated from the airbag cushion 110, the speed at which the gas of the airbag cushion 110 may be discharged increases.

The cover member 120 may be formed of the same material as the airbag cushion 110. Since the cover member 120 may cover the vent hole 113, the cover member 120 may reduce the amount of gas discharged through the vent hole 113 at the initial stage where the airbag cushion 110 may be deployed while being expanded.

The vent tether 130 may be connected to the cover member 120. When the airbag cushion 110 is expanded, the vent tether 130 may pull the cover member 120 so as to further open the vent hole 113. The vent tether 130 may be manufactured by weaving cloth or stacking cloth in synthetic resin.

When the airbag cushion 110 is expanded, the vent tether 130 may further open the vent hole 113 to increase the amount of gas discharged through the vent hole 113. Thus, since the expansion of the airbag cushion 110 may be reduced while the internal pressure of the airbag cushion 110 relatively decreases, the surface of the airbag cushion 110 may be moved to some extent.

Thus, when the head of the passenger collides with the airbag cushion 110 in case of a collision of the vehicle, a buffering time may be extended. The buffering time corresponds to a time period from a point of time that the head comes in contact with the airbag cushion 110 to a point of time that a reaction force of the airbag cushion 110 is applied to the head.

Since the point of time that the reaction force of the airbag cushion 110 is applied to the head after the collision of the vehicle may be delayed, an impact time may be buffered by a buffer time. The buffer time corresponds to a time period from the point of time that the head of the passenger comes in contact with the airbag cushion 110 to the point of time that the reaction force is applied. Furthermore, since the collision acceleration of the head may be reduced by the buffering operation of the airbag cushion 110, the damage of the head may be reduced.

The release device 140 may be connected to the vent tether 130. When the internal pressure of the airbag cushion 110 reaches a preset pressure, the release device 140 may release the vent tether 130 having pulled the cover member 120, such that the cover member 120 may cover the vent hole 113 again.

In the present exemplary embodiment, the release device 140 includes a restraining part 143, a restraint release part 145, a time measuring unit 141, and a controller 147.

The restraining part 143 may restrain an end of the vent tether 130. The restraint release part 145 may release the vent tether 130 from the restraining part 143, and may remove tension applied to the vent tether 130.

The time measuring unit 141 may measure an injection time required for injecting gas into the airbag cushion 110, and delivers the measured injection time to the controller 147.

When the injection time measured by the time measuring unit 141 reaches a preset time, the controller 147 may determine that the internal pressure of the airbag cushion 110 has reached the preset pressure, and may control the restraint release part 145 to release the vent tether 130 by controlling the cover member 120. In FIG. 7, reference numeral 130a represents a portion of the vent tether 130, which may be cut by the restraint release part 145.

The preset time indicates a time required for the internal pressure of the airbag cushion 110 to reach a predetermined pressure after gas is injected. The preset time may be changed depending on the amount of gas injected per unit time and the size of the airbag cushion 110. The preset time may be predetermined through a test of injecting gas into the airbag cushion 110.

When the gas injection time reaches the preset time, the release device 140 may release the restraint of the vent tether 130. Then, the cover member 120 may cover the vent hole 113 such that the surface of the airbag cushion 110 may be slightly moved.

Since the reaction force of the airbag cushion 110, applied to the head of the passenger, may be reduced, an impact load transmitted to the neck through the head may be reduced. As the shock load transmitted to the neck is reduced, the possibility of neck damage may be reduced.

The restraining part 143 may be formed in various shapes such as a ring, screw, and fastening structure. The restraint release part 145 may include an explosive cutting part for cutting the vent tether 130 by exploding powder.

Furthermore, the restraint release part 145 may include a motor which rotates the restraining part 143 so as to separate the vent tether 130 from the restraining part 143. The restraint release part 145 may include various types of structures as long as they can control the vent tether 130 pulling the cover member 120.

The vent tether 130 may be cut when a predetermined magnitude of tension is applied. For example, the vent tether 130 may have a cut line (not illustrated) formed thereon. As the predetermined magnitude of tension is applied to the vent tether 130, the vent tether 130 may be cut along the cut line.

In this case, the time measuring unit 141 or the controller 147 for releasing the vent tether 130 may not be applied.

The cover member 120 may be connected to the inner circumference of the vent hole 113, and the vent tether 130 may be disposed in the airbag cushion 110. Thus, since the cover member 120 is pulled toward the inside of the airbag cushion 110 by the vent tether 130 when the airbag cushion 110 is expanded, the cover member 120 may be separated from the vent hole 113, and the amount of gas discharged through the vent hole 113 may be increased.

Since the cover member 120 may be moved by the tension of the vent tether 130, the opening degree of the vent hole 113 may be adjusted even though a separate opening/closing device is not applied.

The cover member 120 may be connected to the circumference of the vent hole 113 by a sewed part 121. Since the cover member 120 may be connected to the circumference of the vent hole 113 by the sewed part 121, the cover member 120 may be easily connected to the airbag cushion 110.

The sewed part 121 may be sewed at a portion of the circumference of the vent hole 113. For example, the sewed part 121 may be sewed at the left and right sides of the vent hole 113.

Alternatively, the sewed part 121 may be sewed at the left and right sides and the rear of the vent hole 113. The sewed part 121 may be applied in various shapes, as long as a portion of the circumference of the vent hole 113 can be sewed to the airbag cushion 110.

Since the sewed part 121 may be sewed only at a portion of the circumference of the vent hole 113, gas may be discharged through the other portion of the circumference of the vent hole 113, where the sewed part 121 is not formed.

As described above, the cover member 120 may be fixed to the airbag cushion 110 by the sewed part 121. Thus, when the tension of the vent tether 130 is removed from the cover member 120, the cover member 120 may adhere to the inner surface of the airbag cushion 110, thereby reducing the amount of gas discharged through the vent hole 113.

The vent tether 130 may be connected to a portion of the peripheral part of the cover member 120, where the sewed part 121 may not be formed. Thus, when the vent tether 130 pulls the not-sewed portion of the cover member 120 in a case where the airbag cushion 110 is expanded, the not-sewed portion of the cover member 120 may be separated from the inner surface of the airbag cushion 110. Then, the vent hole 113 may be further opened.

As described above, the cover member 120 may be fixed to the airbag cushion 110 by the sewed part 121. Thus, when the tension of the vent tether 130 is removed from the cover member 120, the cover member 120 may cover the vent hole 113 again.

The cover member 120 may have the communication hole 123 which communicates with the vent hole 113 and may have a smaller size than the vent hole 113.

The internal gas of the airbag cushion 110 may be discharged to the outside through the communication hole 123 and the vent hole 113, regardless of whether the cover member 120 covers the vent hole 113. At this time, the airbag cushion 110 may be not completely expanded, but expanded to such an extent that the surface thereof may be slightly moved.

When the head of a passenger collides with the airbag cushion 110 in case of a collision of the vehicle, a buffer time may be extended, the buffer time corresponding to a time period from a point of time that the head comes in contact with the airbag cushion 110 to a point of time that a reaction force of the airbag cushion 110 is applied to the head. Furthermore, since the collision acceleration of the head may be reduced by the buffering operation of the airbag cushion 110, the damage possibility of the head and neck may be reduced.

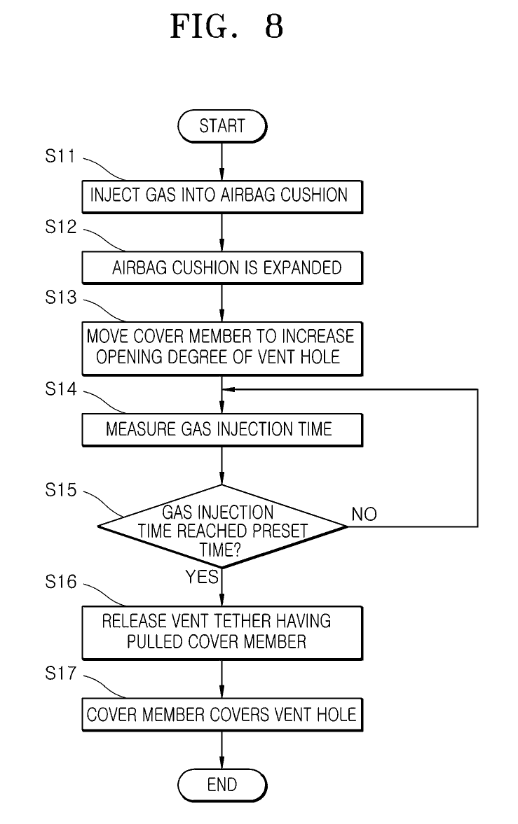

FIG. 8 is a flowchart illustrating a method of controlling an airbag apparatus in accordance with an embodiment of the present invention. Referring to FIGS. 5 to 8, the method of controlling the airbag apparatus in accordance with the embodiment of the present invention and the effect thereof will be described.

When a vehicle collides with an object, the inflator may inject gas into the airbag cushion 110 at step S11. As the gas is injected into the airbag cushion 110, the airbag cushion 110 may be deployed while being expanded, at step S12.

When the airbag cushion 110 is expanded, the vent tether 130 may pull the cover member 120 and increases the opening degree of the vent hole 113 in the airbag cushion 110, thereby increasing the speed at which the gas may be discharged, at step S13 (refer to FIGS. 4 to 6).

At this time, when the airbag cushion 110 is expanded to such an extent that the vent tether 130 is linearly unfolded, a portion of the cover member 120, at which the sewed part 121 is not formed, may be pulled by the vent tether 130.

Since the cover member 120 may be separated from the inner surface of the airbag cushion 110, the speed at which the internal gas of the airbag cushion 110 may be discharged to the outside through the vent hole 113 may increase. At this time, the airbag cushion 110 may not be completely expanded, but expanded to such an extent that the surface thereof may be slightly moved.

Thus, when the head of a passenger collides with the airbag cushion 110, a buffering time may be extended. The buffering time corresponds to a time period from a point of time that the head comes in contact with the airbag cushion 110 to a point of time that a reaction force of the airbag cushion 110 is applied to the head.

Since the point of time that the reaction force of the airbag cushion 110 is applied to the head after the collision of the vehicle may be delayed, an impact applied to the head may be buffered by a buffer time. The buffer time corresponds to a time period from the point of time that the head of the passenger comes in contact with the airbag cushion 110 to the point of time that the reaction force is applied. Furthermore, since the collision acceleration of the head may be reduced by the buffering operation of the airbag cushion 110, the possibility of head damage may be reduced.

The release device 140 may measure a gas injection time at step S14. The controller 147 may receive the gas injection time measured by the release device 140, and determine whether the measured gas injection time reached a preset time, at step S15.

When determining that the measured gas injection time reached the preset time, is the release device 140 may release the restraint of the vent tether 130 at step S16 (refer to FIG. 8).

At this time, the restraint release part 145 of the release device 140 may cut an end portion of the vent tether 130 by exploding powder. The restraint release part 145 may include various types of structures as long as they can release the restraint of the vent tether 130.

As the restraint of the vent tether 130 is released, tension applied to the cover member 120 may be removed. Then, the cover member 120 may return to the original position and cover the vent hole 113, at step S17. Thus, the airbag cushion 110 may not be tightly expanded, but may maintain a state in which the surface thereof can be slightly moved.

Thus, since the reaction force of the airbag cushion 110, applied to the head, may be reduced, an impact load transmitted to the neck through the head may be reduced. As the impact load transmitted to the neck is reduced, the possibility of neck damage may be reduced.

Next, a second example of the cover member in the airbag apparatus in accordance with the embodiment of the present invention will be described.

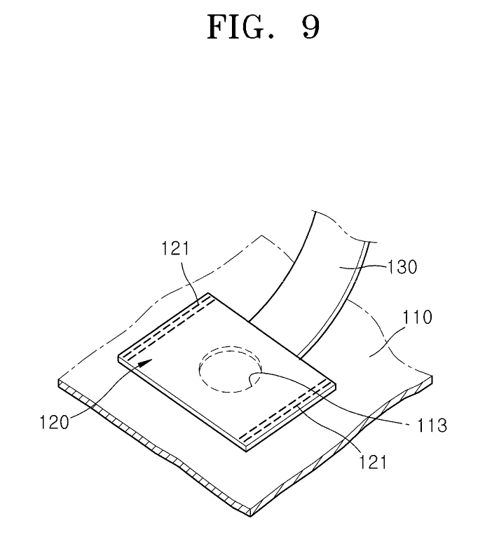

FIG. 9 is an expanded view of a second example of the cover member in the airbag apparatus in accordance with another exemplary embodiment. Referring to FIG. 9, the cover member 120 may have no communication hole formed therein, and thus completely covers the vent hole 113. Thus, the internal gas of the airbag cushion 110 may be discharged only through the vent hole 113.

As the cover member 120 is pulled by the tension of the vent tether 130, the vent hole 113 may be opened. At this time, the gas of the airbag cushion 110 may be discharged to the outside through the vent hole 113. When the restraint release part 145 of the release device 140 releases the restraint of the vent tether 130, the cover member 120 may prevent the gas discharge by closing the vent hole 113.

When the airbag cushion 110 is expanded, the airbag apparatus and the method of controlling thereof in accordance with the exemplary embodiments may increase the opening degree of the vent hole 113. Thus, an impact may be buffered from the point of time that the head comes in contact with the airbag cushion 110 to the point of time that the reaction force is applied.

Furthermore, since the collision acceleration of the head may be reduced by the buffering operation of the airbag cushion 110, the possibility of head damage may be reduced.

Furthermore, when it is determined that the inner pressure of the airbag cushion 110 has reached the preset pressure, the airbag apparatus and the method of controlling thereof may release the restraint of the vent tether 130 and increase the opening degree of the vent hole 113.

Thus, since the reaction force of the airbag cushion 110, applied to the head, can be reduced, an impact load transmitted to the neck may be reduced, which makes it possible to reduce the possibility of neck damage.

The controller 147 and/or one or more components thereof, may be implemented via one or more general purpose and/or special purpose components, such as one or more discrete circuits, digital signal processing chips, integrated circuits, application specific integrated circuits, microprocessors, processors, programmable arrays, field programmable arrays, instruction set processors, and/or the like. In this manner, the features, functions, processes, etc., described herein may be implemented via software, hardware (e.g., general processor, digital signal processing (DSP) chip, an application specific integrated circuit (ASIC), field programmable gate arrays (FPGAs), etc.), firmware, or a combination thereof. As such, the controller 147 and/or one or more components thereof may include or otherwise be associated with one or more memories (not shown) including code (e.g., instructions) configured to cause the controller 147 and/or one or more components thereof to perform one or more of the features, functions, processes, etc., described herein.

The memories may be any medium that participates in providing code to the one or more software, hardware, and/or firmware components for execution. Such memories may be implemented in any suitable form, including, but not limited to, non-volatile media, volatile media, and transmission media. Non-volatile media include, for example, optical or magnetic disks. Volatile media include dynamic memory. Transmission media include coaxial cables, copper wire, and fiber optics. Transmission media can also take the form of acoustic, optical, or electromagnetic waves. Common forms of computer-readable media include, for example, a floppy disk, a flexible disk, hard disk, magnetic tape, any other magnetic medium, a compact disk-read only memory (CD-ROM), a rewriteable compact disk (CDRW), a digital video disk (DVD), a rewriteable DVD (DVD-RW), any other optical medium, punch cards, paper tape, optical mark sheets, any other physical medium with patterns of holes or other optically recognizable indicia, a random-access memory (RAM), a programmable read only memory (PROM), and erasable programmable read only memory (EPROM), a FLASH-EPROM, any other memory chip or cartridge, a carrier wave, or any other medium from which information may be read by, for example, a controller/processor.

Although preferred embodiments of the invention have been disclosed for illustrative purposes, those skilled in the art will appreciate that various modifications, additions, and substitutions are possible, without departing from the scope and spirit of the invention as defined in the accompanying claims.

What is claimed is:

1. An airbag apparatus comprising:
an airbag cushion having a vent hole;
a cover member covering the vent hole;
a vent tether connected to the cover member and configured to adjust an opening degree of the vent hole by pulling the cover member when the airbag cushion is expanded; and
a release device connected to the vent tether, and configured to release the vent tether from pulling the cover member.

2. The airbag apparatus of claim 1, wherein the release device comprises:
a restraining part coupled to the vent tether; and
a restraint release part configured to release the vent tether from pulling the cover member.

3. The airbag apparatus of claim 2, wherein the restraint release part comprises a cut line formed on the vent tether, and
when tension applied to the vent tether is increased, the vent tether is configured to be cut along the cut line.

4. The airbag apparatus of claim 2, wherein the restraint release part is coupled to the vent tether and configured to cut the vent tether by exploding powder.

5. The airbag apparatus of claim 2, wherein the release device comprises:
a time measuring unit configured to measure an injection time during which gas is injected into the airbag cushion; and
a controller configured to control the restraint release part to release the vent tether from pulling the cover member when the injection time reaches a preset time.

6. The airbag apparatus of claim 1, wherein the cover member covers the vent hole and is installed in the airbag cushion, and
the vent tether is connected to the cover member and the release device in the airbag cushion.

7. The airbag apparatus of claim 6, wherein the cover member is fixed to the airbag cushion by a sewed part through which the cover member is sewed to the airbag cushion, and
a portion of the peripheral part of the cover member is sewed to the airbag cushion through the sewed part.

8. The airbag apparatus of claim 7, wherein the vent tether is connected to a portion of the cover member, to which the sewed part is not applied.

9. The airbag apparatus of claim 1, wherein the cover member has a communication hole which communicates with the vent hole and has a smaller diameter than the vent hole.

10. A method of controlling an airbag apparatus, comprising:
injecting gas into an airbag cushion having a vent hole formed therein;
increasing an opening degree of the vent hole by pulling a cover member covering the vent hole using a vent tether when the airbag cushion is expanded; and
releasing the vent tether from pulling the cover member such that the cover member covers the vent hole when an internal pressure of the airbag cushion reaches a preset pressure.

11. The method of claim 10, wherein the releasing of the vent tether comprises:
measuring an injection time of gas supplied into the airbag cushion; and
releasing, by a release device, the vent tether from pulling the cover member when the injection time reaches a preset time.

12. The method of claim 10, wherein in the increasing of the opening degree of the vent hole,
the vent tether increases the opening degree of the vent hole by pulling a portion of the peripheral part of the cover member, which is not sewed to the airbag cushion.

13. The method of claim 11, wherein in the releasing of the vent tether,
the release device restraining the vent tether coupled to the cover member releases the vent tether such that the cover member covers the vent hole.
